(19) United States
(12) Patent Application Publication
(10) Pub. No.: US 2009/0102199 A1
(43) Pub. Date: Apr. 23, 2009

(54) Wave Energy Generator

(76) Inventor: Ivan Voropaev, Queensland (AU)

Correspondence Address: JOHN ALEXANDER GALBREATH, 2516 CHESTNUT WOODS CT, REISTERSTOWN, MD, 21136, US

(21) Appl. No.: 12/300,462

(22) PCT Filed: May 16, 2007
(86) PCT No.: PCT/AU07/00658

§ 371 Date: Nov. 12, 2008

(30) Foreign Application Priority Data
May 17, 2006 (AU) 2006022066

(51) Int. Cl. F03B 13/14

(52) U.S. Cl. 290/53

(57) ABSTRACT

The present invention relates to a generator for generating power from a wave. The generator includes a body defining a plurality of chambers for receiving the wave, and a first set of non-return valves through which air from respective chambers can pass. A first vessel receives air from the first set of non-return valves and, in turn, a turbine receives air from the first vessel to generate power. A second vessel receives air from the turbine. The generator also includes a second set of non-return valves through which air can pass from the second vessel and into respective chambers, thus completing the fluid circuit.

### TECHNICAL FIELD

The present invention relates to a generator for generating power from wave energy.

### BACKGROUND

With the depletion of fossil fuel resources and the increasing effects of climate change on our environment, renewable energy is becoming more desirable on a worldwide scale. Renewable energy is energy derived from resources that are regenerative or, for all practical purposes, cannot be depleted. Renewable energy involves using natural energy sources such as sunlight, wind, tides and geothermal heat to generate power.

Harnessing tidal energy (or tidal power) involves capturing the energy contained in moving water such as tides and open ocean currents. There are two types of tidal energy systems that can be used to extract tidal energy: kinetic energy systems, having the moving water of rivers, tides and open ocean currents as their energy source; and potential energy systems having the difference in height (or head) between high and low tides as their energy source. Kinetic energy systems are gaining in popularity because of their lower ecological impact when compared with potential energy systems which, in turn, require the construction of barrages or dams. Many coastal sites worldwide are being examined for their suitability to produce tidal (current) energy.

### SUMMARY OF THE INVENTION

According to another aspect of the present invention, there is provided a generator for generating power from wave energy, the generator including:
a first valve assembly for converting wave energy to higher pressure air;
a second valve assembly for converting wave energy to lower pressure air; and
a turbine for coupling in fluid communication with the valve assemblies to generate the power.

The valve assemblies may include a common body defining a plurality of chambers for receiving a wave. The body may include an array of rigidly interconnected columns each defining a separate chamber. Typically, the array may include up to one hundred columns.

The first valve assembly may include:
a first set of non-return valves through which air from respective chambers can pass; and
a first vessel for receiving air from the first set of non-return valves and in which the higher pressure air is formed;

The second valve assembly may include:
a second vessel for receiving air from the turbine; and
a second set of non-return valves through which air can pass from the second vessel and into respective chambers.

The vessels may be elongate and extend along opposite sides of the array. Alternatively, the vessels may extend within the body.

Each non-return valve may include a flap which is pivotally mounted to a wall separating the vessel and body, and which covers an aperture defined in the wall.

The generator may further include ballast means for ballasting the generator amid the wave activity. The ballast means may include a pair of elongate ballast tanks extending along the body and which can be filled with material so that the depth of the body relative to the wave can be varied. Alternatively, the ballast means may include a pair of sets of spaced apart ballast tanks.

The turbine may be an electrical turbine for generating electricity.

According to another aspect of the present invention, there is provided a generator for generating power from a waver the generator including:
a body defining a plurality of chambers for receiving the wave;
a first set of non-return valves through which air from respective chambers can pass;
a first vessel for receiving air from the first set of non-return valves;
a turbine for receiving air from the first vessel and for generating the power;
a second vessel for receiving air from the turbine; and
a second set of non-return valves through which air can pass from the second vessel and into respective chambers.

According to another aspect of the present invention, there is provided a generator for generating power from wave energy, the generator including:
a valve assembly for converting wave energy to air having a different pressure to atmospheric pressure; and
a turbine for coupling in fluid communication with said valve assembly to generate the power.

According to another aspect of the present invention, there is provided a kit for forming a generator for generating power from a wave, the kit including:
a body defining a plurality of chambers for receiving the wave;
a first set of non-return valves through which air from respective chambers can pass;
a first vessel for receiving air from the first set of non-return valves and for coupling in fluid communication to a turbine;
a second vessel for coupling to receive air from the turbine; and
a second set of non-return valves through which air can pass from the second vessel and into respective chambers.

According to another aspect of the present invention, there is provided a generator for generating power from wave energy, the generator including:
a first transducer for converting wave energy to higher pressure air;
a second transducer for converting wave energy to lower pressure air; and
a turbine for coupling in fluid communication with the transducers to generate the power.

According to another aspect of the present invention, there is provided a floating wave power plant including the previously described generator.

Preferably the floating wave power plant includes a number of rigidly interconnected hulls that support a plurality of the generators.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a top perspective view of a generator in accordance with an embodiment of the present invention;

FIG. 2 is a top perspective view of the generator of FIG. 1 whereby the generator has its roof removed to show its internal structure;

FIG. 3 is a top perspective view of a floating wave power plant including a plurality of generators according to an embodiment of the present invention; and

FIG. 4 is a sectional end view of a generator for incorporation into the floating wave power plant of FIG. 3.

### DETAILED DESCRIPTION OF PREFERRED EMBODIMENTS

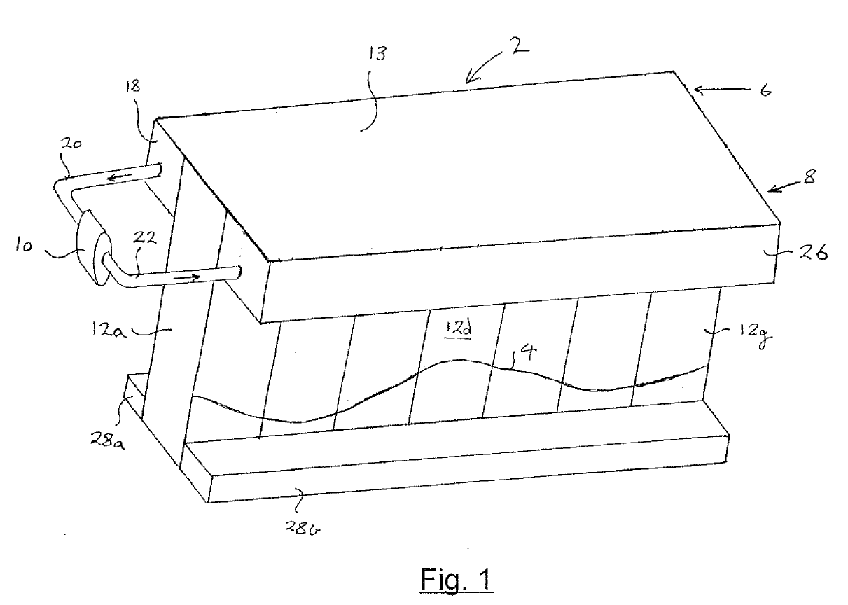

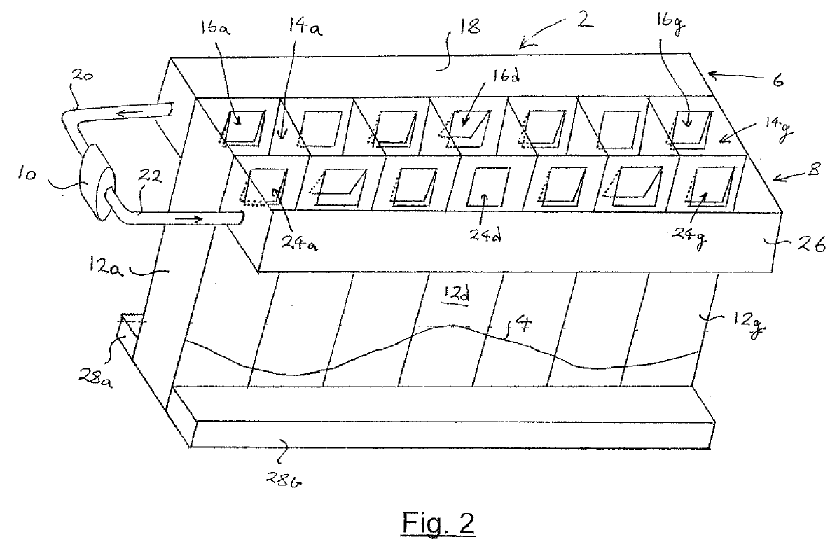

According to an embodiment of the present invention, there is provided a generator 2 for generating power from wave energy (or activity) as shown in FIGS. 1 and 2. FIGS. 1 and 2 show the generator 2 in operation at an instant in time with reference to a traveling water wave 4 which travels along the length of the generator 2. The generator 2 includes a high pressure valve assembly 6 for converting wave energy to higher pressure air (i.e. higher pressure than atmospheric pressure) and a low pressure valve assembly 8 for converting wave energy to lower pressure air (i.e. lower pressure than atmospheric pressure). An electricity turbine 10 is coupled in fluid communication between the valve assemblies 6, 8 to generate electrical power. A detailed description of the generator 2 is provided below.

Referring to FIG. 2, the valve assemblies 6,8 include a common elongate body in the form of a one-dimensional array of hollow and rigidly interconnected columns 12a-g. Each column 12 defines a respective chamber 14 for receiving the wave 4. Although FIG. 2 shows seven columns 12a-g, in practice up to one hundred columns 12 would be fastened together to form the body. The generator 2 has a roof portion or lid 13 (FIG. 1) which covers and is in sealing engagement with the chambers 14 and pressure vessels 18, 26.

The high pressure valve assembly 6 includes a first set of non-return valves 16a-g through which air from respective chambers 14a-g can pass. The high pressure valve assembly 6 also includes a high pressure vessel 18 for receiving air from the first set of non-return valves 16 so that air in the sealed vessel 18 is pressurized (i.e. compressed). Air is impeded from returning from the high pressure vessel 18 to the chambers 14 via the non-return valves 16. In the presently described embodiment, each non-return valve 16 includes a flap which is pivotally mounted to an internal wall separating the vessel 18 and the columns 12. Each flap covers a respective aperture defined in the internal wall and, in use, pivots so as to enter the high pressure vessel 18.

The generator 2a further includes a high pressure hose 20 for receiving high pressure air from the high pressure vessel 18 and providing the air to the turbine 10. The turbine 10 has a rotor with blades and is turned by the flowing air to generate electrical power. The flowing air exits the turbine 10 via a low pressure hose 22 and then enters the low pressure valve assembly 8.

The low pressure valve assembly 8 includes a low pressure vessel 26 for receiving airflow from the low pressure hose 22. The low pressure valve assembly 8 also includes a second set of non-return valves 24a-g through which air can pass from the low pressure vessel 26 and into respective chambers 14a-g so as to produce a vacuum in the low pressure vessel 26. Air is impeded from returning from the chambers 14 to the low pressure vessel 26 via the non-return valves 24. As before, each non-return valve 24 includes a flap which is pivotally mounted to an internal wall separating the vessel 26 and the columns 12. Each flap covers a respective aperture defined in the internal wall and, in use, pivots so as to enter a corresponding chamber 14.

The generator 2 also includes a pair of elongate ballast tanks 28a,b extending along opposite sides of the body to stabilize the floating generator 2. The ballast tanks 28a,b can be filled with water (or sand) so that the depth of the body relative to the wave 4 (and waters surface) can be varied. Ideally, the ballast tanks submerge the generator 2 so that the trough of the wave 4 is located proximal its base.

When a wave peak is present in a chamber 14, air in that chamber 14 is pushed into the high pressure vessel 18 through a corresponding non-return valve 16 to a maximum extent. In contrast, when a wave trough is present in the chamber 14, air is sucked from the low pressure vessel 26 through a corresponding non-return valve 24 to a maximum extent.

As can be seen from FIG. 2, the traveling wave 4 instantaneously has a peak within chamber 14d and two troughs in chambers 14b,f. Accordingly, the non-return valves 24b, 16d, and 24f are wide open allowing maximum airflow there-through. Conversely, the non-return valves 16b, 24d and 16f are fully closed allowing negligible airflow there-through. The non-return valves 16a, 24a, 16c, 24c, 16e, 24e, 16g and 24g are neither wide open nor fully closed and some air flows there-through.

The generator 2 is longer than the average ocean wavelength, and may therefore typically be 40 meters in length.

A person skilled in the art will appreciate that many embodiments and variations can be made without departing from the ambit of the present invention.

In the preferred embodiment, the generator 2 includes a pair of valve assemblies 6,8 between which the turbine 10 is coupled. In an alternative embodiment, the generator 2 need only include a single one of the valve assemblies 6,8 with the turbine 10 being coupled between that valve assembly and the atmosphere. In this manner, the pressure differential between the valve assembly and the atmosphere would cause the generator to generate power.

The skilled person will understand that the generator 2 may be provided in kit form for transportation to, and later assembly, at the site of operation.

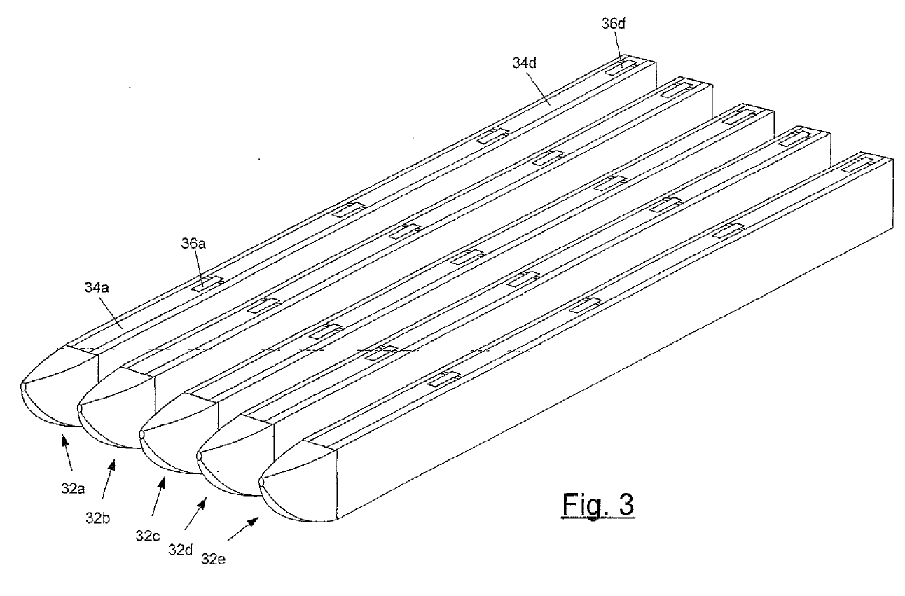

Referring to FIG. 3, there is depicted a floating wave power plant 30 which is made up of an array of rigidly interconnected hulls 32a, . . . , 32e. Although FIG. 3 shows five hulls, more may be incorporated in order to scale up power production. One material that the inventor has envisaged for making the hulls is a suitable concrete, although of course other materials might also be used. In the embodiment of the floating wave power plant that is depicted, each of the hulls supports four generators. For example, hull 32a supports generators 34a, . . . 34d, each with its own corresponding turbine 36a, . . . 36d. Of course, more or fewer, than four generators might be incorporated per hull as required.

Rather than each generator having its own turbine, an alternative embodiment of the floating wave power plant might instead include a plurality of valve assembly pairs aligned in parallel and coupled to a single turbine 10 with manifolds, for example.

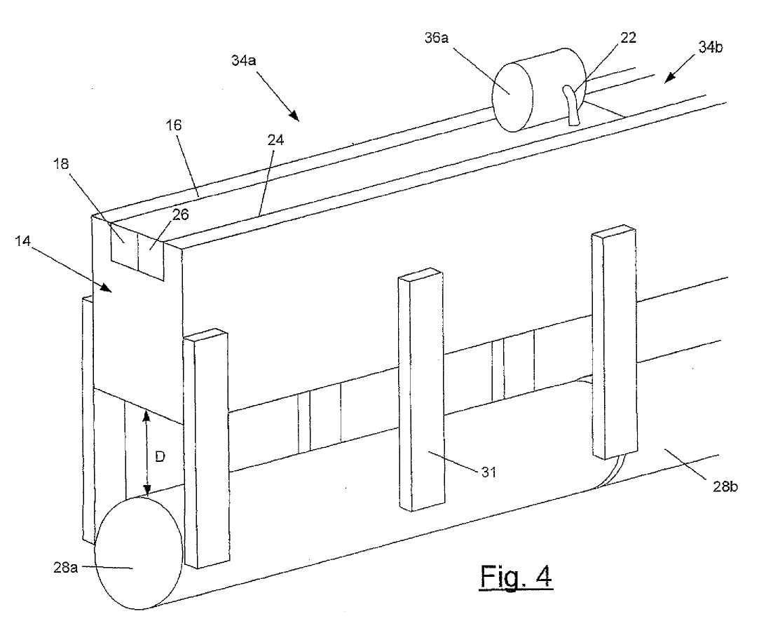

FIG. 4 is a view of one exemplary generator 34a of FIG. 3. Where it is useful to do so, like indicia have been used to refer to similar features previously discussed with reference to FIGS. 1 and 2.

In the embodiment of FIG. 4, the vessels 18, 26 are located within and extend along a central upper portion of the rectangular body defining the chambers 14. The body includes a plurality of inner partitioning walls which separate the chambers 14, with each partitioning wall defining an upper recess for accommodating and supporting the vessels 18, 26. The turbine 36 is mounted above the vessels 18, 26. Pipe 22 connects one side of turbine 36 to vessel 26. A corresponding pipe connects the far side of the turbine 36 to vessel 18.

A ballast tank 28a is suspended beneath chamber 14 by legs 31. Locating the ballast tank beneath chamber 14 assists in preventing the apparatus rolling up on the ocean waves and ensures that the center of gravity of the generator remains below the average water level. Preferably gap D is large enough to not impede entry of the waves into the partitioned chamber 14 so that wave energy is not needlessly dissipated.

In a further embodiment of the invention the ballast tanks might be disposed between the hulls so that they are not directly beneath the chamber 14.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A generator for generating power from wave energy, the generator including: a first valve assembly for converting wave energy to higher pressure air; a second valve assembly for converting wave energy to lower pressure air; and a turbine for coupling in fluid communication with the valve assemblies to generate the power.

2. A generator as claimed in claim 1, wherein the valve assemblies include a common body defining a plurality of chambers for receiving a wave.

3. A generator as claimed in claim 2, wherein the body includes an array of rigidly interconnected columns each defining a separate chamber.

4. A generator as claimed in claim 2, wherein the first valve assembly includes: a first set of non-return valves through which air from respective chambers can pass; and a first vessel for receiving air from the first set of non-return valves and in which the higher pressure air is formed.

5. A generator as claimed in claim 4, wherein the second valve assembly includes: a second vessel for receiving air from the turbine; and a second set of non-return valves through which air can pass from the second vessel and into respective chambers.

6. A generator as claimed in claim 5, wherein the vessels are elongate and extend along opposite sides of the body.

7. A generator as claimed in claim 5, wherein each non-return valve includes a flap which is pivotally mounted to a wall separating a vessel and the body, and which covers a corresponding aperture defined in the wall.

8. A generator as claimed in claim 1, further including ballast means for ballasting the generator amid wave activity.

9. A generator as claimed in claim 8, wherein the ballast means includes a pair of elongate ballast tanks extending along the valve assemblies and which can be filled with material so that the floating depth of the generator can be varied.

10. A generator as claimed in claim 1, wherein the turbine is an electrical turbine for generating electricity.

11. A generator for generating power from a wave, the generator including: a body defining a plurality of chambers for receiving the wave; a first set of non-return valves through which air from respective chambers can pass; a first vessel for receiving air from the first set of non-return valves; a turbine for receiving air from the first vessel and for generating the power; a second vessel for receiving air from the turbine; and a second set of non-return valves through which air can pass from the second vessel and into respective chambers.

12. A generator as claimed in claim 11 wherein the body includes an array of columns each defining a separate chamber.

13. A generator as claimed in claim 11, wherein the vessels are elongate and extend along opposite sides of the body.

14. A generator as claimed in claim 11, wherein each non-return valve includes a flap which is pivotally mounted to a wall separating a vessel and the body, and which covers a corresponding aperture defined in the wall.

15. A generator as claimed in claim 11, further including ballast means for ballasting the generator amid wave activity.

16. A generator as claimed in claim 15, wherein the ballast means includes one or more ballast tanks extending along the body and which can be filled with material so that the floating depth of the body relative to the wave can be varied.

17. A generator for generating power from wave energy, the generator including: a valve assembly for converting wave energy to air having a different pressure to atmospheric pressure; and a turbine for coupling in fluid communication with said valve assembly to generate the power.

18. A generator as claimed in claim 17, wherein the valve assembly includes: a set of non-return valves through which air can pass; and a vessel in fluid communication with the set of non-return valves.

19. A kit for forming a generator for generating power from a wave, the kit including: a body defining a plurality of chambers for receiving the wave; a first set of non-return valves through which air from respective chambers can pass; a first vessel for receiving air from the first set of non-return valves and for coupling in fluid communication to a turbine; a second vessel for coupling to receive air from the turbine; and a second set of non-return valves through which air can pass from the second vessel and into respective chambers.

20. A generator for generating power from wave energy, the generator including: a first transducer for converting wave energy to higher pressure air; a second transducer for converting wave energy to lower pressure air; and a turbine for coupling in fluid communication with the transducers to generate the power.

21. A floating wave power plant including one or more generators as claimed in claim 20.

22. A floating wave power plant according to claim 21, including a number of rigidly interconnected floats or hulls supporting the one or more generators.
